(19) United States
(12) Patent Application Publication
(10) Pub. No.: US 2025/0186955 A1
(43) Pub. Date: Jun. 12, 2025

(54) Rotating Detonation Engine Material Synthesizer

(71) Applicant: Alexis Jonas Thoeny, San Jose, CA (US)

(72) Inventor: Alexis Jonas Thoeny, San Jose, CA (US)

(21) Appl. No.: 18/965,747

(22) Filed: Dec. 2, 2024

Related U.S. Application Data
(60) Provisional application No. 63/606,959, filed on Dec. 6, 2023.

(51) Int. Cl. B01J 3/08

(52) U.S. Cl. CPC B01J 3/08

(57) ABSTRACT

A rotating detonation engine material synthesizer and method for continuous synthesis and processing of materials through shock-induced transformations, comprising introducing feedstock materials, including solid particles, liquids, and non-primary reactant gases, into a rotating detonation engine cycle where they undergo shock loading either directly from detonation waves or from shocks produced as detonation by-products, wherein the shock-induced material changes include generating larger crystal structures, forming new crystal structures, phase-changing existing materials, and synthesizing new species through secondary chemical reactions, and wherein the transformed materials are then harvested post-combustion chamber for various applications, such that this continuous synthesis approach offers significant advantages over conventional material processing methods, particularly in production rate and energy efficiency, while providing a versatile platform for creating and modifying materials under unique high-pressure, high-temperature conditions with rapid quenching.

### CROSS-REFERENCE TO RELATED APPLICATIONS

This non-provisional application claims the benefit and priority of U.S. Provisional Application Ser. No. 63/606,959, filed on Dec. 6, 2023, which is hereby incorporated by reference in its entirety, including all references and appendices cited therein, for all purposes.

### FIELD

The present disclosure pertains broadly to methods and technologies for material synthesis within rotating detonation engines (RDEs) and/or rotating detonation combustors (RDCs), which is referred to as a rotating detonation engine material synthesizer (RDEMS. Related features include enhancing material yield and quality, exploring green materials synthesis, and accessing meta-stable material states. These features enable efficient and environmentally friendly material production, with potential applications in resource extraction and materials science.

### SUMMARY

According to some embodiments, the present disclosure is directed to a method for synthesizing materials. The method also includes introducing feedstock materials and reactant(s) into a rotating detonation engine (RDE), where the feedstock materials are selected from examples such as solid particles, liquids, and non-primary reactant gases. The reactants can include solids, liquids and/or gasses.

The method also includes exposing the feedstock material and reactant to shockwaves generated by detonation in or near a combustion chamber of the RDE, wherein the exposure induces a material change in the feedstock material, wherein the material change comprises at least one of: generating larger crystal structures, forming new crystal structures, phase-changing, and synthesizing new chemical species through secondary reactions to create a transformed material. The method also includes harvesting the shocked feedstock post-combustion chamber for various applications. Other embodiments of this aspect include corresponding computer systems, apparatus, and computer programs recorded on one or more computer storage devices, each configured to perform the actions of the methods.

Implementations may include one or more of the following features. The method where introducing feedstock materials may include introducing the materials at one or more of: a plenum upstream of the combustion chamber, within the combustion chamber, or downstream of the combustion chamber. Shocking the feedstock materials may include exposing the materials to at least one of: bulk detonation waves or wall-based detonation waves. The method may include supplementing the material changes using at least one of: plasma discharge, electric field enhancement, acoustic enhancement, or geometric flow features. Harvesting may include using at least one of: cyclonic separation, electrostatic precipitation, direct surface coating, buoyancy-based density separation in settling chambers, and/or density-based segregation systems. Implementations of the described techniques may include hardware, a method or process, or computer software on a computer-accessible medium.

According to some embodiments, the present disclosure is directed to a system for continuous synthesis of materials using a rotating detonation engine (RDE). The system also includes a rotating detonation engine configured to operate continuously. The system also includes a feedstock introduction mechanism for adding feedstock materials into the RDE cycle, where the feedstock materials undergo shock-induced transformation in or near the combustion chamber. The system also includes a harvesting mechanism configured to collect the transformed feedstock materials for further processing or direct application. The system also includes an integrated plant cycle system for recycling process gases, liquids, and solids to enhance yield rates or particle sizes of the synthesized materials. Other embodiments of this aspect include corresponding computer systems, apparatus, and computer programs recorded on one or more computer storage devices, each configured to perform the actions of the methods.

Implementations may include one or more of the following features. The system where the feedstock introduction mechanism may include at least one of: injectors, vibration mechanisms, or venturi devices. The system may include a computer control system configured to monitor and adjust operating parameters of the RDE and feedstock introduction rates. The harvesting mechanism may include a dump tank configured with material separation capabilities. The system may include enhancement devices selected from the group may include of: plasma generators, electric field generators, acoustic devices, and geometric flow modifiers. The integrated plant cycle system includes capability for partial recycling of shocked feedstock back into the RDE. Implementations of the described techniques may include hardware, a method or process, or computer software on a computer-accessible medium.

According to some embodiments, the present disclosure is directed to a method of operating a rotating detonation engine mixed-feedstock system (RDEMS). The method also includes mixing a feedstock with an intake stream may include air and/or oxygen with fuel, where the feedstock is selected from the group may include of solid particulates, liquids, and gases, upstream of a detonation chamber, and where the location of introducing the feedstock may vary in different embodiments; introducing the mixed feedstock and intake stream into a detonation chamber; initiating a detonation wave within the detonation chamber to consume the fuel and oxidizer while simultaneously shock-loading the co-propagating feedstock, resulting in material changes within the feedstock, the material changes may include at least one of principal crystal growth, continued crystal growth, phase-change, and secondary chemistry reactions; allowing the detonation product gases and the shocked feedstock, possibly in a different material state, to be exhausted into a dump tank; extracting the feedstock from the dump tank; and exhausting the detonation product gases from the dump tank to one or more of the following: air, recycling them, or subjecting them to further processing, where the shocked feedstock may be partially recycled back into the intake stream to increase yield fractions for extracted materials from the dump tank. Other embodiments of this aspect include corresponding computer systems, apparatus, and computer programs recorded on one or more computer storage devices, each configured to perform the actions of the methods.

Implementations may include one or more of the following features. The method where the feedstock may include materials selected for producing at least one of: nanodiamonds, graphene, carbon nanotubes, or other similar materials. The method may include controlling the material changes by adjusting at least one of: detonation wave speed, feedstock introduction timing, or combustion chamber pressure. Mixing the feedstock may include introducing the feedstock through multiple entry points to achieve desired concentration distributions. The method may include monitoring the material changes using real-time sensing and analysis. Extracting the feedstock may include using a combination of mechanical and electromagnetic separation techniques. The method may include controlling the dump tank conditions to preserve desired material states. Recycling the shocked feedstock may include selecting specific size fractions for reprocessing. The method may include using the exhausted detonation product gases for power generation. Implementations of the described techniques may include hardware, a method or process, or computer software on a computer-accessible medium.

### BRIEF DESCRIPTION OF THE DRAWINGS

FIG. 1 shows a schematic diagram of a Rotating Detonation Engine Material Synthesizer according to an embodiment of the present disclosure.

FIG. 2 shows a perspective view of a Rotating Detonation Engine according to an embodiment of the present disclosure.

FIG. 3 shows a cross-sectional view of an example RDE according to an embodiment of the present disclosure.

FIG. 4A shows a flowchart illustrating a part of a method of operating a Rotating Detonation Engine Material Synthesizer according to an embodiment of the present disclosure.

FIG. 4B shows a flowchart illustrating another part of the method of operating a Rotating Detonation Engine Material Synthesizer according to an embodiment of the present disclosure.

FIG. 5 shows a block diagram of a computer control system for a Rotating Detonation Engine Material Synthesizer according to an embodiment of the present disclosure.

### DETAILED DESCRIPTION OF EXAMPLE EMBODIMENTS

### Overview

The present disclosure introduces a Rotating Detonation Engine Material Synthesizer (RDEMS) that exploits continuous detonation processes for materials synthesis and transformation. The RDEMS integrates detonation wave dynamics with precise material introduction and control systems, operating at elevated pressures and temperatures characteristic of detonation processes, while maintaining stable detonation wave propagation at supersonic velocities.

An RDEMS of the present disclosure can include an RDE or RDC. A RDE or RDC includes an annular combustion chamber configured to sustain continuous propagation of one or more detonation waves. The RDE or RDC comprises an annular gap formed between concentric inner and outer walls, with fuel and oxidizer injection at one end and exhaust at the opposite end. The combustion process occurs through sequential detonation events propagating circumferentially around the annular chamber at supersonic velocities. The RDE or RDC may incorporate regenerative cooling channels within the walls using primary reactants, water, or other cooling media to enable sustained operation. The chamber walls can be constructed of high-temperature alloys or ceramic composites capable of withstanding the elevated pressures and temperatures characteristic of detonation processes. When configured for material synthesis applications as an RDEMS, the RDE or RDC includes additional features for feedstock introduction, processing, and collection of transformed materials. While some examples may refer to a RDE, this will be understood to be inclusive of a RDC.

The RDEMS architecture comprises an annular combustion chamber with integrated feedstock introduction mechanisms positioned at strategic locations including the plenum, combustion chamber, and downstream sections. These mechanisms, including precision injectors, vibration-assisted devices, and venturi systems, enable the controlled introduction of solid particulates ranging from nanoscale to microscale dimensions, liquids, and non-primary reactant gases. The system maintains detonability limits through equivalence ratio control within established operational ranges, while specialized flow geometries and acoustic isolation systems prevent pressure fluctuation feedback.

The system distinguishes between primary reactant gases (essential for detonation sustainment) and secondary materials (feedstock for transformation). Primary reactants, typically including fuel-oxidizer combinations such as hydrogen/oxygen or methane/air, undergo rapid chemical reactions generating detonation waves. These detonation waves create the processing environment for secondary materials, characterized by high-pressure ratios and rapid temperature gradients.

The RDEMS enables two distinct material transformation mechanisms: fluid/bulk detonation processing and wall-based detonation processing. In fluid/bulk processing, feedstock materials experience uniform exposure to detonation conditions within the primary gas stream. Wall-based processing utilizes material interaction along chamber surfaces, where specialized geometries and surface treatments enhance transformation effects. The system incorporates real-time monitoring and control of detonation parameters, enabling precise manipulation of residence times and exposure conditions.

Material transformation occurs through multiple pathways including nucleation, crystal growth, phase transformation, and chemical species generation. The system achieves this through controlled shock loading, rapid quenching, and precise particle size control facilitated by integrated separation and recycling systems. Process enhancement mechanisms include plasma discharge, electric field modulation, acoustic coupling, and geometric flow modification, enabling access to metastable states and novel material phases.

The RDEMS system supports two distinct material transformation approaches: materials synthesis for creating or modifying nano-to-micron scale particles, and materials processing for size reduction of larger feedstock materials. In materials synthesis operations, the system enables particle formation through nucleation, controlled growth, phase changes, and secondary chemical reactions. For materials processing applications, the system can efficiently reduce the size of millimeter-scale feedstock materials to micro or nano-scale particles, which is particularly valuable for critical minerals processing. This dual-use capability allows the system to serve both advanced materials synthesis needs and industrial-scale materials processing requirements.

### Example Embodiments

The Rotating Detonation Engine Material Synthesizer (RDEMS) integrates detonation engine technology with sophisticated materials synthesis processes. The RDEMS utilizes a rotating detonation engine (RDE) characterized by an annular-gap combustor, comprising a high-pressure plenum and a combustion chamber. This configuration enables operation with either air or pure oxygen as the oxidizer, which is mixed with fuel during transition to the combustion chamber; other examples of oxidizers may include high-test peroxide (HTP), nitrogen tetroxide (NTO), or other suitable reactive agents depending on application requirements. Example fuels may include hydrogen (H2), methane (CH4), acetylene (C2H2), gasoline, ethylene (C2H4), or other suitable hydrocarbon or non-hydrocarbon fuels appropriate for the specific application.

The system can operate across a range of pressure conditions, from near-ambient to high-pressure inputs, and accommodates both fluid/bulk and wall-based detonation mechanisms. The RDEMS incorporates novel elements to facilitate the production of both high-temperature-pressure (HTP) materials and conventional materials processing, demonstrating versatility across multiple applications.

The RDEMS incorporates mechanisms for introducing feedstock materials into various stages of the RDE cycle. These feedstock materials may comprise solid particles, liquids, and non-primary reactant gases. Introduction points include the plenum, fuel stream, detonation chamber, or downstream locations. Feedstock introduction mechanisms may include automated feeders, injectors, vibration-assisted devices for solids, and venturi systems for solids or liquids.

Within the RDE cycle, feedstock materials undergo transformation through multiple mechanisms positioned within or proximal to the combustion chamber. These mechanisms include direct shock-inducing devices, and enhancement technologies such as plasma discharge systems, electric field generators, and acoustic devices, all strategically positioned to maximize material transformation efficiency. The feedstock material can be processed either suspended in the primary reactant gas stream for fluid/bulk detonation or along surfaces for wall-based detonation, experiencing the high-pressure and high-temperature conditions of the detonation wave as it propagates through the reactant mixture. The system's ability to access metastable states and induce rapid phase changes is particularly valuable for novel material synthesis. The system's ability to access metastable states is facilitated by the rapid quenching process inherent to detonation dynamics. This rapid quenching not only enables the stabilization of otherwise transient phases but also supports the induction of rapid phase changes for synthesizing advanced materials with unique structural and chemical properties.

Post-transformation, the modified feedstock is processed through multiple pathways for industrial applications. The RDEMS incorporates harvesting mechanisms for extracting materials from the combustion chamber, including cyclonic separators, diffusion-based separators, or direct deposition systems. The system enables partial recycling of shocked feedstock into the intake stream, optimizing yield rates and particle sizes through iterative processing. Integration with downstream turbine systems allows for simultaneous material synthesis and power generation. The process can be optimized for either nano-to-micro scale synthesis operations—producing new particles, growing existing ones, or inducing phase changes—or for larger-scale materials processing such as critical minerals refinement.

Ultimately, the RDEMS produces a “transformed material” that refers to feedstock that has undergone at least one alteration induced by detonation waves in the RDEMS environment, resulting in changes such as crystal growth, phase transformation, or chemical synthesis. This transformation includes any structural or compositional modifications that occur due to detonation-induced conditions, including temperature, pressure, and secondary reaction effects within the detonation chamber.

The RDEMS is operable across a broad spectrum of feedstock-to-primary reactant ratios, allowing adaptability to varied compositions of primary reactant gases and secondary materials. This flexibility ensures stable detonation under multiple operational conditions, independent of exact mixture ratios, which can be modified to meet specific material synthesis requirements. By enabling a range of compositions, the RDEMS can efficiently maintain detonation wave propagation and facilitate desired material transformations while accommodating feedstock variability.

The RDEMS's operational flexibility derives from its ability to precisely control multiple process parameters. These include the equivalence ratio of primary reactants, the timing and location of feedstock introduction, and the activation of various enhancement mechanisms. While specific operational parameters may vary based on the desired output, the system maintains stable detonation waves across a range of conditions, enabling consistent and reproducible material transformation processes.

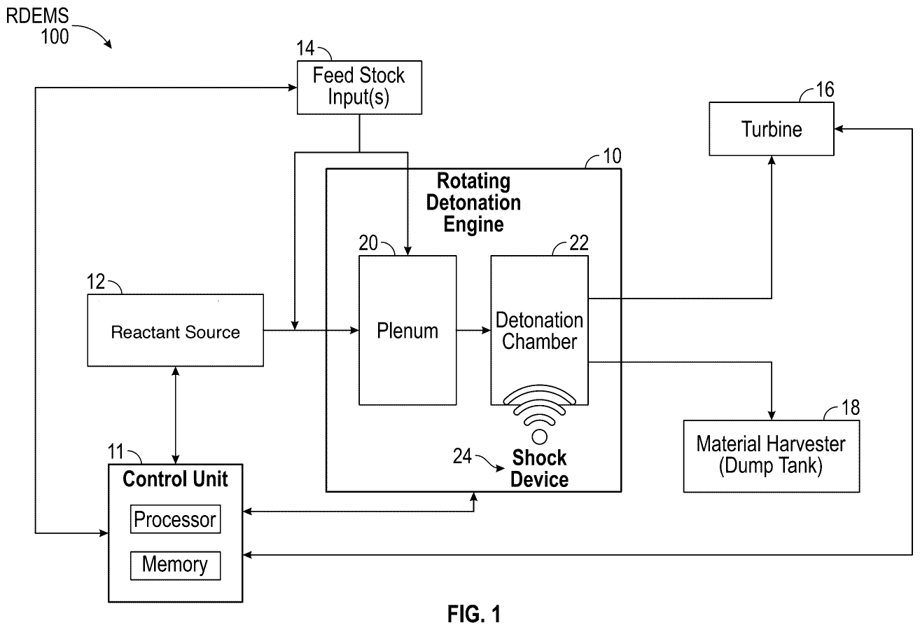

FIG. 1 illustrates the Rotating Detonation Engine Material Synthesizer (RDEMS) 100, a system for continuous material synthesis and transformation. The RDEMS 100 integrates several subsystems that operate together to achieve controlled material processing: a Rotating Detonation Engine (RDE) 10, a reactant source 12, feedstock inputs 14, a turbine 16, and a material harvester 18. Each subsystem performs specific functions while maintaining relationships that enable the material synthesis capabilities of the system as a whole.

The RDEMS is compatible with various feedstock forms, including solid particles, liquids, and gases, each adaptable to the detonation environment. For example, nano- to microscale solid particulates can be introduced into the detonation chamber, allowing for uniform exposure to detonation conditions. Liquid feedstocks may be atomized for homogeneous distribution, and gaseous inputs can seamlessly integrate with the primary reactant flow.

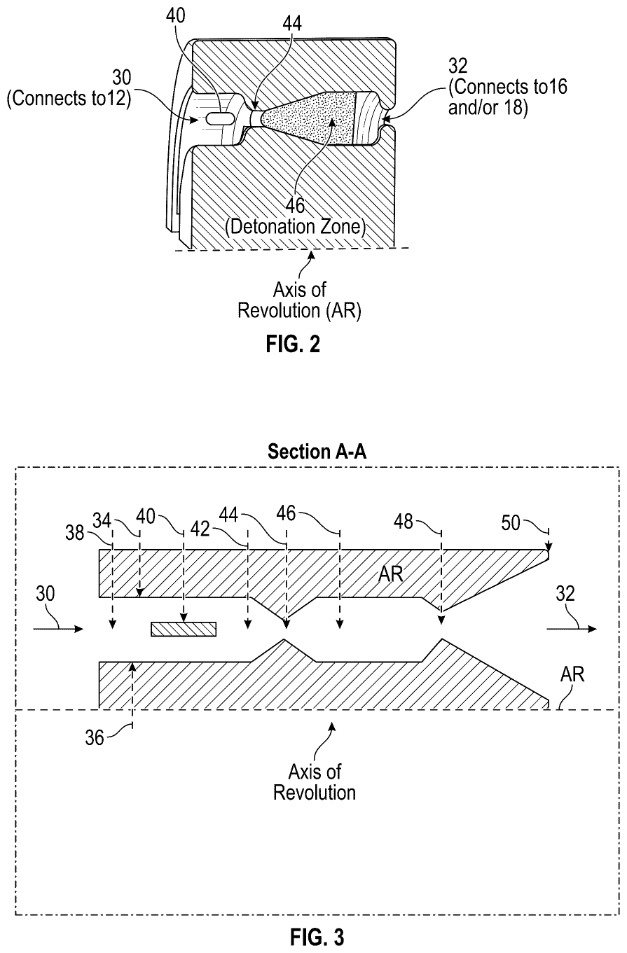

The RDE 10, as shown in both FIGS. 1 and 2, serve as the primary processing unit of RDEMS 100. Unlike conventional detonation engines focused on propulsion, the RDE 10 is adapted for material processing through a configuration comprising a plenum 20, detonation chamber 22, and shock device 24. This adaptation allows control over detonation conditions while maintaining continuous operation, which provides benefits over batch processing methods found in certain prior material synthesis systems.

The reactant source 12 supports oxidizer and fuel delivery control. While traditional RDE systems often operate with atmospheric intake, RDEMS 100 employs a reactant source 12 capable of delivering oxidizing agents at controlled temperature and pressure conditions. The reactant source 12 may include various configurations such as high-pressure compressor systems exceeding 50 atmospheres with temperature control, cryogenic oxygen systems with vaporization control, multi-stage compression systems with intercooling, and hybrid atmospheric/compressed systems for flexibility in operation. These configurations allow control over oxidizer conditions, impacting material transformation processes.

As noted above, the system is compatible with gaseous, liquid, and solid fuels, each requiring specific preparation and injection approaches to ensure proper mixing with the oxidizer. Gaseous fuels such as hydrogen (H2), methane (CH4), acetylene (C2H2), ethylene (C2H4), or propane (C3H8) can be directly injected and mixed with the oxidizer stream. Liquid fuels may require additional preparation steps such as atomization or vaporization prior to mixing with the oxidizer, with suitable options including kerosene, jet fuel (JP-8), various grades of gasoline, liquid natural gas (LNG), liquid hydrogen (LH2), rocket propellant (RP-1), or other liquid hydrocarbon fuels appropriate for detonation applications. Solid fuels, which may be introduced as fine particulates or powders, can include coal dust, metal particles such as aluminum or boron, or other energetic materials that can support detonative combustion when properly mixed with the oxidizer. The fuel injection and preparation systems are configured to ensure proper atomization, mixing, and distribution to support stable detonation wave propagation while maintaining material synthesis capabilities, with specific injection and mixing strategies optimized for each fuel type.

The feedstock inputs 14 of RDEMS 100, illustrated in FIG. 1, introduce materials for processing or transformation through multiple strategically positioned entry points. These inputs accommodate solid particles, liquids, and non-primary reactant gases, with automated feed mechanisms such as precision injectors, vibration-assisted devices for solids, and venturi systems. The positioning and timing of feedstock introduction influence transformation outcomes, with the system introducing materials at the plenum 20, within the detonation chamber 22, or at downstream locations depending on desired material properties.

The RDEMS system incorporates multiple methods for introducing feedstock materials, accommodating both fluid-suspended and wall-based processing approaches. For fluid-suspended processing, feedstock materials are introduced into the primary reactant stream through precision injectors or venturi systems, enabling uniform distribution within the detonation zone.

Wall-based processing employs specialized introduction mechanisms to position feedstock materials along chamber surfaces, where they encounter intense shock loading from wall-propagating detonation waves. This process is driven by the formation of a stronger localized shockwave, often referred to as a lambda-foot shockwave, which amplifies the transformation effects on the materials. This specificity may be included to highlight the underlying science or omitted if “intense shock loading” sufficiently conveys the concept. This dual-approach capability enables optimization of processing conditions based on feedstock characteristics and desired transformation outcomes. The system can dynamically adjust between these introduction methods during operation, allowing for complex processing sequences when required.

The turbine 16, depicted in FIG. 1 downstream of RDE 10, serves to support energy recovery and process control. This subsystem extracts mechanical work from high-energy detonation products while maintaining backpressure control suited for material processing conditions. The turbine 16 may be configured with power extraction mechanisms, including electrical generators or mechanical drives, allowing energy recovery that enhances system efficiency.

The material harvester 18, shown interfacing with the RDE 10 in FIG. 1, employs separation technologies adapted to specific material characteristics. This subsystem collects transformed materials through techniques such as cyclonic separation, electrostatic precipitation, or direct surface coating, depending on particle size distribution and material properties. The harvester 18 includes feedback control systems that adjust collection parameters based on real-time monitoring of product characteristics if desired.

The RDEMS control system (control unit 11) includes adaptive optimization capabilities to dynamically adjust operating parameters based on real-time monitoring of material transformation metrics. By tracking factors such as particle size distribution, transformation efficiency, and detonation wave characteristics, the system can modify parameters—such as feedstock introduction timing, mixture ratio, mixture composition, residence time, quench rate, and so forth—to achieve optimal synthesis outcomes.

The control unit 11 manages the operation of the RDEMS 100. The control unit 11 is configured to monitor and adjust various parameters across the RDEMS subsystems to ensure/maintain detonation propagation while promoting optimal material synthesis conditions and outcomes. The control unit 11 interfaces with several components of the RDEMS 100, as illustrated in FIG. 1. It controls the composition, temperature, and pressure of the oxidizer and fuel supplied by the reactant source 12, adjusting these parameters according to the requirements of the material transformation process. The control unit also regulates the timing, location, and rate of feedstock introduction into the system via the feedstock inputs 14, coordinating the operation of various feed mechanisms such as injectors and vibration-assisted devices.

Furthermore, the control unit 11 interacts with the Rotating Detonation Engine (RDE) 10, monitoring and controlling detonation wave characteristics, chamber pressure, and other important parameters that influence material transformation. It can activate and modulate various enhancement devices integrated into the RDE, such as plasma discharge systems or electric field generators, to improve processing conditions.

Downstream of the RDE, the control unit 11 manages the operation of the turbine 16, adjusting parameters to maintain the desired backpressure and energy recovery efficiency. It also controls the material harvester 18, adapting collection parameters based on real-time monitoring of product characteristics.

The control unit 11 is programmed to execute advanced control algorithms that enable real-time optimization of the RDEMS process. These algorithms incorporate feedback from various sensors distributed throughout the system, allowing the control unit to dynamically adjust operating parameters in response to changes in feedstock properties, detonation behavior, and material transformation efficiency. The system integrates multiple sensor types to monitor, control, and optimize detonation and material transformation processes. Optical probes could be used to capture high-speed visual data enabling real-time observation of detonation wave propagation, flame dynamics, and particle interactions.

Other sensors could perform spectroscopic measurements including absorption and emission analysis. These sensors provide insights into the spatial and temporal behavior of detonation processes. Pressure transducers measure dynamic pressure changes within the chamber, providing data on shockwave stability, detonation intensity, and material interaction with propagating waves. Thermocouples monitor temperature gradients in system components, ensuring thermal conditions remain within the desired range for effective material synthesis and system integrity. These sensors enable a comprehensive understanding of the operational environment, supporting precise adjustments to system parameters for enhanced efficiency and material quality. The control unit's programming also includes predictive models that anticipate the effects of parameter adjustments on material synthesis outcomes. These models enable proactive optimization, allowing the control unit to modify operating conditions in advance to maintain consistent product quality and yield.

FIG. 2 is a perspective view of a Rotating Detonation Engine (RDE) 10, which serves as a processing unit within the Rotating Detonation Engine Material Synthesizer (RDEMS). In this embodiment, the RDE 10 comprises a detonation chamber configured with an annular geometry, which supports continuous detonation wave propagation within the chamber. This design enables high-frequency detonation cycles that facilitate material transformation processes under controlled shock and thermal conditions.

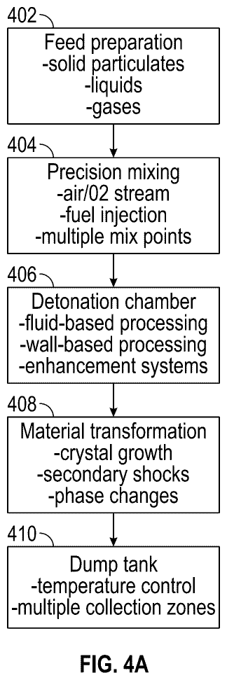

FIG. 3 presents a cross-sectional of another example RDE, revealing the internal components supporting material transformation. It will be understood that if the detailed view of FIG. 3 were to be rotated about the axis of revolution AR, an RDE annular combustor would be seen with the addition of feedstock supply for materials synthesis. The axis of revolution AR, shown as a dashed line, represents the central axis about which the detonation wave propagates circumferentially within the annular chamber. When the cross-section is rotated 360 degrees about AR, it forms the complete annular combustion chamber where the detonation wave continuously travels in a circular path around the central axis, processing feedstock materials as it propagates.

The intake/inlet 30 connects to reactant source 12, featuring variable geometry that accommodates flow rates from 1-10 kg/s while maintaining pressure control. Other flow rates from 0.1-300 kg/s can be used as would be known by one of ordinary skill in the art. The exit 32 interfaces with downstream components of RDEMS 100, designed to withstand temperatures exceeding 2000K and incorporating thermal management systems.

The outer wall 34 and inner wall 36 of RDE 10 form the annular combustion space, constructed from high-temperature alloys or ceramic composites capable of withstanding temperatures up to 2500K (can be higher) and pressures up to 50 atmospheres. It will be understood that in some instances pressures could be instantaneously higher than 50 atm (average chamber pressures could exceed 100 atm, meaning instantaneous is ˜1000 atm or more).

Both of the outer wall 34 and/or inner wall 36 include regenerative cooling (either gas or liquid) channels and thermal barrier coatings, allowing sustained operation while supporting material integrity. This thermal management system supports continuous operation without compromising process conditions. In one embodiment, the outer wall 34 and inner wall 36 of RDE 10 form the annular combustion space, constructed from high-temperature alloys or ceramic composites capable of withstanding temperatures up to 2500K and pressures up to 50 atmospheres. Both inner wall 36 and outer wall 34 incorporate regenerative cooling channels that can utilize primary reactant gases, water, or other cooling media. The cooling channels are arranged in a counter-flow configuration to maximize heat transfer efficiency. The walls also include thermal barrier coatings and can implement transpiration or film cooling through precisely positioned injection ports. This comprehensive thermal management system enables sustained operation while maintaining material integrity and precise control of combustion chamber conditions.

Within RDE 10, the plenum 38 receives oxidant and fuel from intake 30, maintaining pressure distribution between 10-50 atmospheres with temperatures ranging from ambient to 800K. The injector/supplier 40 meters both reactant fuel and feedstock materials through engineered orifices that enable atomization and mixing. The mixed plenum 42 contains the combined reactants, with composition managed to support detonation conditions.

The flow restriction 44 acts as an acoustic isolator between plenum 38 and detonation chamber 46, using specific geometries to maintain stable detonation waves. The detonation chamber 46 sustains wave propagation under high-pressure and high-temperature conditions, with average static pressures up to 100 atmospheres and temperatures exceeding 3000K. The nozzle throat 48 and nozzle exit 50 complete the flow path, with geometrics optimized for material processing while maintaining chamber pressure and residence time.

The geometry illustrated in FIG. 3, showing the inlet 30, combustion chamber 46, nozzle throat 48, and exit 50, represents one example configuration of the RDE. It will be understood that alternative geometric configurations may be employed for any or all of these components. For instance, the inlet 30 may incorporate different flow path designs to achieve desired mixing characteristics; the combustion chamber 46 may utilize various cross-sectional profiles to optimize detonation wave propagation; and the nozzle throat 48 and exit 50 geometries may be modified to achieve specific pressure ratios, residence times, or flow characteristics. Additionally, the relative dimensions and proportions of these components may be varied while maintaining the fundamental annular nature of the device when the cross-section is revolved around AR. These geometric variations enable the optimization of the RDEMS for different feedstock materials, operating conditions, and desired material transformation outcomes.

Referring to FIGS. 1-3 collectively, the RDEMS 100 supports control over material transformation through the integration of components with monitoring and control systems. Sensors throughout the system track parameters such as pressure, temperature, and flow, enabling adjustments to optimize material synthesis outcomes. This level of control, combined with the continuous process, supports the production of advanced materials with controlled properties.

The RDEMS 100 supports two categories of material transformation: materials synthesis at the nano-to-micron scale and materials processing at larger scales. In synthesis operations, the system achieves particle formation through nucleation and growth processes within the detonation chamber 22, supports controlled growth of pre-existing particles through exposure to detonation conditions, enables phase changes including metastable states, and facilitates secondary chemical reactions under high-pressure, high-temperature conditions. These capabilities provide certain advantages over conventional synthesis methods, particularly in production rate and energy efficiency.

The RDEMS 100 is particularly suited for synthesizing several categories of advanced materials. In the field of catalysts, the system can produce high-entropy-alloy nano-catalysts combining multiple metallic elements in metastable configurations, potentially valuable for energy conversion and chemical processing applications. For high-temperature applications, the system enables the synthesis of advanced ceramics including carbides, nitrides, and borides, with controlled stoichiometry and crystal structure. In energy storage applications, the system can produce next-generation electrode materials for batteries, including complex oxides and composite structures with precisely controlled morphology. The rapid quenching capabilities of the system are particularly valuable for accessing metastable phases that are difficult to achieve through conventional synthesis methods.

In materials processing applications, the RDEMS 100 offers particular advantages for critical minerals processing. The system can efficiently reduce the size of mineral feedstocks containing valuable elements such as cobalt, lithium, and rare earth elements, facilitating subsequent separation and refinement processes. The high-energy detonation environment enables rapid size reduction of these materials from millimeter-scale to micro or nano-scale particles, potentially reducing the number of processing steps required compared to conventional crushing and grinding methods. The system's ability to process these materials continuously, rather than in batch operations, provides significant throughput advantages over traditional processing methods.

The input conditions for RDEMS 100 can be adjusted across parameters to support desired material transformations. The system accommodates both low and high-pressure inputs through reactant source 12 and feedstock inputs 14, with flexibility in pressure ratios between primary reactant gases and secondary feedstock materials. Temperature conditions can vary from near-ambient to highly elevated states depending on transformation processes, with control maintained through the plenum 38 and injector/supplier 40 systems.

The RDEMS 100 demonstrates remarkable flexibility in input pressure conditions, accommodating both high-pressure and near-atmospheric pressure inputs. Similar to modern turbojet engines, the system can operate effectively with low-pressure inputs by leveraging internal mechanisms to achieve the required pressure conditions within the reaction zone. This flexibility enables more economical operation in scenarios where pre-compression of inputs is not necessary, while still maintaining the capability for high-pressure operation when desired for specific material transformations. The system's internal geometry and flow management features enable pressure amplification within the reaction zone regardless of input pressure conditions.

Material transformation within RDEMS 100 occurs through two primary detonation mechanisms controlled within the detonation chamber 46. In fluid/bulk detonation, feedstock materials suspended within the primary reactant gas stream experience exposure to detonation conditions. Alternatively, wall-based detonation involves material interaction along the surfaces of outer wall 34 and inner wall 36, providing transformation conditions suitable for certain materials or processes. These base mechanisms can be augmented through technologies integrated into the RDE 10, including arc/plasma discharge systems, electric field enhancement, acoustic devices, and surface geometries that generate additional shock waves and flow features.

The wall-based detonation processing mechanism offers unique capabilities for material modification. Through precise control of surface temperatures and detonation wave interactions, the system can create specialized surface structures and coatings. This approach is particularly effective for processes requiring controlled crystal growth or phase transformation, as the wall surfaces can be engineered to promote specific crystallographic orientations or phase transitions. The system can alternate between wall-based and fluid-based processing during operation, enabling multi-step transformation sequences that leverage the advantages of each approach.

Material transformation within the RDEMS can be enhanced through various supplementary mechanisms integrated into the system. Plasma discharge systems can be incorporated to generate charged species that catalyze specific reactions or enhance transformation rates. Electric field enhancement, achieved through strategic placement of electrodes within the chamber, can influence particle behavior and transformation pathways. Acoustic coupling devices can be employed to modify local pressure conditions and enhance mixing or particle interactions. Additionally, specialized geometric features within the chamber can generate secondary shock waves, strong shockwaves from shock reflection, and flow patterns that enhance transformation effectiveness. These enhancement mechanisms can be selectively activated and controlled based on specific processing requirements.

The output processing capabilities of RDEMS 100 include pathways for material collection and system optimization. Integration with turbine 16 enables simultaneous material synthesis and power generation, while material harvester 18 can be configured for direct coating applications or particle collection. The system includes recycling capabilities where partially transformed materials can be reintroduced through feedstock inputs 14 to achieve desired particle sizes or chemical compositions, enhancing yield rates and supporting control over product characteristics.

The recycling capabilities of the RDEMS 100 incorporate sophisticated material sorting and classification. When processing critical minerals, the system can selectively recycle specific size fractions or composition ranges to optimize yield and purity. The recycling process can be configured to operate in multiple modes: a high-throughput mode for bulk processing, a high-precision mode for specialized materials, or a hybrid mode balancing throughput and precision. The system's ability to dynamically adjust recycling parameters enables optimization of both processing efficiency and product quality.

While power generation is an example of a product cycle ancillary use, an ancillary process refers to any operation that utilizes the product gases exiting the RDEMS system. These processes can be configured to extract additional value from the high-energy product gases through different pathways. As noted, one pathway involves power generation, where the product gases can be expanded through a turbine to produce mechanical energy for direct mechanical drive applications or to drive an electrical generator for power production. Another pathway involves process heating, where the thermal energy of the product gases is transferred through heat exchangers to provide heating for other industrial processes, such as material pre-heating, steam generation, or facility heating requirements. These ancillary processes can be implemented individually or in combination to maximize the overall system efficiency and utility of the product gases.

The effectiveness of material transformation in RDEMS 100 depends on control of system parameters. Feed mechanisms within feedstock inputs 14, such as injectors, vibration systems, and venturi devices, are coordinated to support material distribution and mixing. The timing and location of feedstock introduction—whether at plenum 38, within detonation chamber 46, or downstream—influence transformation outcomes. These parameters are adjusted based on real-time monitoring of process conditions and product characteristics through sensor and control systems.

The RDEMS 100 employs process control capabilities that enable real-time optimization of material transformation outcomes. The control unit 11 continuously monitors key parameters including particle size distribution, transformation efficiency, and product characteristics. Based on these measurements, the control unit 11 can automatically adjust operating parameters such as feedstock introduction timing, detonation wave characteristics, and residence time to optimize yield and product qualities. This adaptive control capability enables the system to maintain optimal processing conditions despite variations in feedstock properties or environmental conditions. For critical minerals processing, the control unit 11 can optimize size reduction efficiency while minimizing energy consumption, while for materials synthesis applications, it can precisely control conditions to achieve desired particle characteristics.

For particle size control, the control unit 11 can simultaneously adjust multiple parameters including feedstock introduction timing, detonation wave speed, and quench rate. The control unit 11 architecture employs predictive modeling to anticipate the effects of parameter adjustments, enabling proactive optimization rather than purely reactive control. For critical minerals processing, the control unit 11 can automatically adjust processing conditions based on real-time analysis of feedstock composition and desired output characteristics. This adaptive control enables the processing of variable feedstock materials while maintaining consistent output quality.

The RDEMS 100 enables control over material synthesis conditions through the coordinated operation of all subsystems. The combination of input control through reactant source 12 and feedstock inputs 14, transformation conditions within RDE 10, and collection through material harvester 18 enables continuous production of advanced materials with controlled properties. This approach, coupled with the system's capacity to maintain stable detonation waves across various conditions, supports advancements in materials processing technology.

The RDEMS 100 has significant advantages in production rate capabilities compared to conventional materials processing methods. For nano-to-micron scale materials synthesis, the system can achieve production rates exceeding 5,000 times that of traditional chemical vapor deposition processes, with corresponding reductions in per-unit production costs. For critical minerals processing, the continuous operation capability enables throughput rates that substantially exceed conventional batch processing methods. These advantages derive from the system's unique combination of continuous operation, intense processing conditions, and precise control capabilities, enabling both high-volume production and consistent product quality.

The system's performance advantages extend across multiple operational metrics. Beyond the 5,000-fold improvement in production rate for nanomaterials compared to chemical vapor deposition, the system demonstrates significant advantages in energy efficiency, typically requiring 60-80% less energy per unit mass of processed material compared to conventional methods. For critical minerals processing, the system can achieve size reduction ratios exceeding 1000:1 in a single pass, while conventional grinding circuits typically require multiple stages to achieve similar reduction ratios. These performance advantages derive from the unique combination of continuous operation and highly efficient energy transfer through the detonation process.

### Alternative Embodiments

The implementation of an electrostatic field to enhance yield and detonation efficacy in reactive materials is a notable advancement. In the context of the Rotating Detonation Engine with Material Synthesis (RDEMS), this enhancement can be achieved by introducing a voltage differential across the walls of the combustion chamber, either on the inner or outer surfaces. This electrical biasing could catalyze an increase in the rate of material synthesis and augment the quality of the resultant substances. The application of an electric field in an RDE combustion apparatus predominantly offers advantages by influencing the behavior of charged particles within the detonation wave. This interaction may induce a preferential accumulation of charged species adjacent to the inner or outer walls of the combustion chamber, potentially intensifying the propagation and strength of the detonation wave along these surfaces.

The integration of a plasma discharge within the RDEMS framework has yet to be explored until now. Introducing a plasma discharge within the RDEMS chamber may generate a spectrum of charged entities, thereby modulating specific chemical reactions. This modulation confers benefits in terms of material synthesis rates or in the characteristics of the detonation wave propagation.

### Example Methods of Use

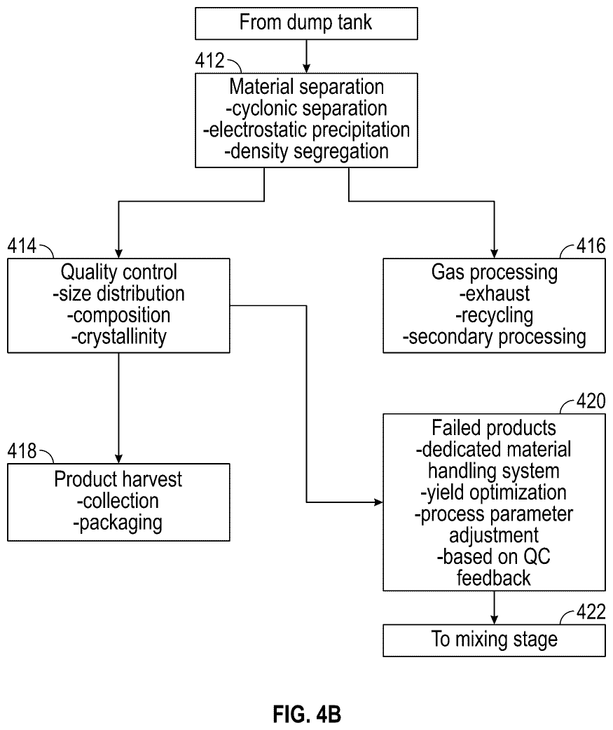

FIGS. 4A and 4B collectively illustrate an example method for material synthesis in a rotating detonation engine. The method includes a step 402 where feedstock materials are grouped into three primary categories: solid particulates with controlled size distributions from nano to microscale, liquids with specific viscosity ranges, and gases maintained at regulated pressures and temperatures.

The method includes a step 404 where the categorized feedstock materials enter a precision mixing stage designed to combine the materials with the intake stream, comprising either air at monitored humidity levels or oxygen at specified purity levels, along with precisely metered fuel injection. Multiple mixing points allow for the staged introduction of different feedstock types.

The method includes a step 406 where the mixed feedstock and intake stream proceed to enter the detonation chamber, configured for either fluid-based or wall-based detonation processing. For fluid-based processing, the materials are suspended within the primary gas stream, while wall-based processing utilizes surface interaction effects. Enhancement systems including plasma discharge units, electric field generators, and acoustic coupling devices can be activated at this stage.

The method includes a step 408 where the materials undergo shock-induced transformation within the detonation chamber. This transformation includes multiple concurrent processes: principal crystal growth under controlled detonation conditions, continued crystal development in secondary shock waves, phase changes at specific pressure-temperature combinations, and secondary chemistry reactions enhanced by the detonation environment.

The method includes a step 410 where the transformed materials enter the dump tank system, which maintains specific temperature and pressure conditions to preserve desired material states. The dump tank incorporates multiple collection zones optimized for different product types.

The method includes a step 412 where sophisticated material separation processes begin, employing a combination of cyclonic separation for larger particles, electrostatic precipitation for fine particles, and density-based segregation systems. This stage separates product materials from process gases with high efficiency. Additionally, the method supports direct-coating applications, wherein transformed materials are deposited directly onto substrates as they exit the detonation chamber. This approach eliminates the need for intermediate collection and processing steps, enabling the immediate utilization of synthesized materials in applications such as surface coatings, functional films, or structural enhancements. This direct-coating capability not only improves efficiency but also expands the system's utility in advanced manufacturing processes.

The method includes a step 414 where the separated product materials undergo comprehensive quality control analysis, including particle size distribution measurements, chemical composition verification, crystallinity assessment, and specific property testing based on target material requirements.

The method includes a step 416 where process gases from the separation stage are directed through three possible pathways: controlled exhaust to the atmosphere through emission management systems, recycling back to the intake stream with precise flow control and conditioning, or routing to secondary processing systems for additional material recovery.

The method includes a step 418 where products meeting all quality specifications advance to final harvest through specialized collection and packaging systems designed to maintain product integrity and prevent contamination. The method includes a step 420 where products falling outside acceptable parameters are recycled back to the mixing stage through a dedicated material handling system. This recycling pathway enables yield optimization through multiple processing cycles, with process parameters adjusted based on quality control feedback from previous cycles.

The method includes a step 422 where the failed products are routed back to the mixing stage through a dedicated transfer system designed to maintain material integrity during recycling. This transfer system comprises temperature-controlled transport lines, vibration-isolated conveying mechanisms, and pressure-regulated feed channels that prevent material degradation or unwanted agglomeration during transfer. The system incorporates multiple sensing stations that monitor material conditions, automated flow control valves that regulate recycling rates, and precision dosing equipment that ensures optimal mixing ratios with fresh feedstock. Real-time feedback loops continuously adjust transfer parameters including temperature gradients, conveying velocities, and insertion timing based on both current quality control data and historical processing metrics. The system also includes bypass channels for emergency diversion, multiple reintegration points at the mixing stage for uniform distribution, and automated cleaning cycles to prevent cross-contamination between different material batches. This sophisticated recycling architecture enables dynamic optimization of the reprocessing stream while maintaining the strict control requirements necessary for high-quality material synthesis.

While the method described in steps 402-422 represents one example implementation of the rotating detonation engine material synthesis process, it should be understood that numerous variations, modifications, and alternative embodiments are contemplated within the scope of this disclosure. The specific sequence of steps, the introduction points of various materials, the types of enhancement methods employed, the precise separation techniques utilized, and the recycling pathways implemented may be varied or combined in different ways to achieve desired material transformation outcomes. Additional steps may be added, steps may be removed or modified, and the order of certain steps may be rearranged while still maintaining the fundamental principles of the material synthesis process. Furthermore, the various subsystems and components described may be scaled, adjusted, or modified to accommodate different feedstock materials, production volumes, or specific material transformation requirements. The control systems and monitoring methods may likewise be adapted to suit particular processing needs while maintaining the basic principles of operation described herein.

### Example Use Case

An aerospace manufacturing company is exploring the development of advanced alloys for their cutting-edge aircraft engines using the RDEMS system. These alloys are required to endure extreme temperatures and pressures while being lightweight and structurally sound.

The focus is on employing the RDEMS system to synthesize high-performance aerospace alloys in powder or particulate form, suitable for the rigorous demands of next-generation aircraft engines. The company selects a blend of titanium, aluminum, and nickel in powder form as the primary material input. Alongside these powders, specific gases crucial for the alloying process are introduced into the RDEMS system's intake. In the detonation chamber, this powdered mixture undergoes exposure to high pressure and temperature conditions due to the detonation wave. These extreme conditions enable rapid alloying and the creation of novel crystal structures not achievable through conventional methods.

The output from the RDEMS process, primarily in powder or particulate form, is then collected. This material undergoes additional processing steps such as cooling and grinding, followed by thorough quality inspection to ensure it meets stringent specifications. The synthesized alloy powders are then tested for their thermal and structural properties. The output can either be collected or directly coated onto other substrate surfaces.

In another example use case, a battery manufacturer is developing electrode materials using the RDEMS system. The goal is to create complex oxide structures with controlled morphology and defined electrochemical properties for energy storage capacity and charging rates.

The process begins with metal oxide precursors in powder and liquid forms, combined with dopant materials to modify conductivity. These materials are introduced into the RDEMS system's intake with oxidizing gases. Within the detonation chamber, the pressure and temperature cycling enables the formation of hierarchical structures and metastable phases. The quenching capabilities of the system maintain these metastable states.

The electrode materials are collected and undergo electrochemical testing. The material properties, including particle size distribution, crystal structure, and surface area, are analyzed. Products meeting specifications advance to prototype battery assembly, while materials outside parameters are recycled through the system with adjusted processing conditions.

A critical minerals processor is utilizing the RDEMS system for extraction of rare earth elements from raw ore feedstock. The operation reduces processing steps while increasing recovery rates of elements including cobalt, lithium, and other rare earth components.

The operation begins with sized mineral feedstock introduced into the system with chemical additives for phase transformation. The conditions within the detonation chamber facilitate size reduction from millimeter-scale particles to micro or nano-scale particles while inducing phase changes that affect separation processes. The system's operation enables continuous processing compared to batch methods.

The processed materials undergo separation processes to isolate rare earth elements. The system's particle size reduction influences the liberation of components. Materials requiring additional processing are recycled through the system with parameters modified based on composition analysis.

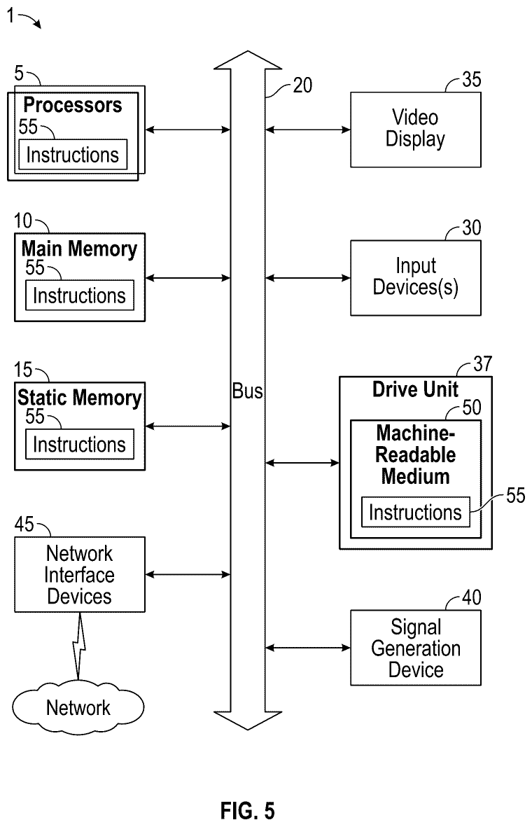

FIG. 5 is a diagrammatic representation of an example machine in the form of a computer system 1, within which a set of instructions for causing the machine to perform any one or more of the methodologies discussed herein may be executed. The system can be used to control any one or more of the components disclosed above.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein.

One embodiment of the control system (computer) for the RDEMS disclosed herein is how chemical or propulsion cycle systems are typically controlled in a closed-loop fashion for a particular setting. However, the RDEMS control system could automatically optimize the material yields through process control targets. For example, if the system knew the synthesized particle size exiting the dump tank, it could automatically change input parameters with the goal to maximize particle size.

The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for synthesizing materials, comprising:
introducing a feedstock material into a rotating detonation engine (RDE), wherein the feedstock material comprises at least one of solid particles, liquids, and non-primary reactant gases;
introducing a reactant into the RDE in combination with the feedstock material;
subjecting the feedstock material and the reactant to shockwaves generated by detonation in or near a combustion chamber of the RDE, wherein the exposure induces a material change in the feedstock material, wherein the material change comprises at least one of: generating larger crystal structures, forming new crystal structures, phase-changing, and synthesizing new chemical species through secondary reactions to create a transformed material; and
harvesting the transformed material exiting the combustion chamber.

2. The method of claim 1, wherein introducing the feedstock material comprises introducing the feedstock material at one or more of:
a plenum upstream of the combustion chamber,
within the combustion chamber, and
downstream of the combustion chamber.

3. The method of claim 1, wherein subjecting the feedstock material to shock waves comprises exposing the feedstock material to at least one of:
bulk detonation waves, and
wall-based detonation waves.

4. The method of claim 1, further comprising supplementing the material changes using at least one of:
plasma discharge,
electric field enhancement,
acoustic enhancement, and
geometric flow features.

5. The method of claim 1, wherein harvesting comprises using at least one of:
cyclonic separation,
electrostatic precipitation, and
direct surface coating.

6. A system for continuous synthesis of materials using a rotating detonation engine (RDE), comprising:
a rotating detonation engine (RDE) configured to operate continuously;
a feedstock introduction mechanism configured to add feedstock materials into the RDE, wherein the feedstock materials are subjected to shock-induced transformation in a combustion chamber of the RDE;
a harvesting mechanism configured to collect transformed feedstock materials; and
an integrated plant cycle system configured to recycle process gases, liquids, and solids to enhance yield rates or particle sizes of the transformed feedstock materials.

7. The system of claim 6, wherein the feedstock introduction mechanism comprises at least one of:
an injector,
a vibration mechanism, and
a venturi device.

8. The system of claim 6, further comprising a computer control system configured to monitor and adjust operating parameters of the RDE and feedstock introduction rates.

9. The system of claim 6, wherein the harvesting mechanism comprises a dump tank configured with material separation capabilities.

10. The system of claim 6, further comprising enhancement devices selected from any of: plasma generators, electric field generators, acoustic devices, and geometric flow modifiers.

11. The system of claim 6, wherein the integrated plant cycle system is configured to partially recycle shocked feedstock back into the RDE.

12. A method of operating a Rotating Detonation Engine Mixed-Feedstock System (RDEMS), comprising:
mixing a feedstock with an intake stream comprising an oxidizer and a fuel, wherein the feedstock comprises at least one of solid particulates, liquids, and gases;
introducing the mixed feedstock and intake stream into a detonation chamber;
initiating a detonation wave within the detonation chamber to consume the fuel and oxidizer while simultaneously subjecting the mixed feedstock to shock waves, resulting in a material change within the mixed feedstock to produce a transformed product, wherein the material change comprises at least one of: principal crystal growth, continued crystal growth, phase-change, and secondary chemical reactions;
exhausting detonation product gases and the transformed product into a dump tank;
extracting the transformed product from the dump tank; and
exhausting the detonation product gases from the dump tank.

13. The method of claim 12, further comprising partially recycling the transformed product back into the intake stream to increase yield fractions for extracted materials from the dump tank.

14. The method of claim 12, further comprising controlling the material changes by adjusting at least one of:
detonation wave speed,
a feedstock introduction timing, or
combustion chamber pressure.

15. The method of claim 12, wherein mixing the feedstock comprises introducing it through multiple entry points to achieve a desired concentration distribution.

16. The method of claim 12, further comprising monitoring the material changes using real-time sensing and analysis.

17. The method of claim 12, wherein extracting the shocked mixed feedstock comprises using a combination of mechanical and electromagnetic separation techniques.

18. The method of claim 12, further comprising controlling conditions within the dump tank to preserve a desired material state.

19. The method of claim 12, wherein partially recycling the shocked mixed feedstock comprises selecting specific size fractions for reprocessing.

20. The method of claim 12, further comprising utilizing the exhausted detonation product gases for power generation, wherein the power generation is achieved through one or more of: driving a turbine to produce mechanical or electrical energy or transferring thermal energy via a heat exchanger for process heating.
